(19) United States
(12) Patent Application Publication
(10) Pub. No.: US 2002/0126167 A1
(43) Pub. Date: Sep. 12, 2002

(54) Method of driving ink jet type recording head

(76) Inventor: Shigeru Kimura, Niigata (JP)

Correspondence Address: DICKSTEIN SHAPIRO MORIN & OSHINSKY LLP, 41ST Floor, 1177 Avenue of the Americas, New York, NY, 10036-2714, US

(21) Appl. No.: 10/080,389

(22) Filed: Feb. 25, 2002

(30) Foreign Application Priority Data
Mar. 6, 2001 (JP) 2001-061435

(51) Int. Cl. B41J 29/38

(52) U.S. Cl. 347/11

(57) ABSTRACT

The present invention provides a method of driving an ink jet type recording head, which obtains a sufficient ink droplet discharge velocity even if an applied voltage is low, and also uses a driving pulse signal that can keep a relation between a voltage change time and a natural period of a generated pressure wave and the like, at a high accuracy.

The driving pulse signal continuously has a first period T1 in which a pressure generating chamber 11 is expanded, a second period T2 in which an expansion state of the pressure generating chamber 11 is kept, and a third period T3 in which the pressure generating chamber 11 is contracted, and when a natural period of the pressure generating chamber 11 is assumed to be Tc, the first period T1 and the second period T2 satisfy the equation given by:

3Tc/8≦T1+T2≦5Tc/8

### BACKGROUND OF THE INVENTION

1. Field of the Invention

The present invention relates to a method of driving an ink jet type recording head, and more particularly to a method of driving an ink jet type recording head, which can obtain a sufficient ink droplet discharge velocity even if an applied voltage is low.

2. Description of the Related Art

A droplet on demand type ink jet method is well known for discharging an ink droplet from a nozzle communicated to a pressure generating chamber by using an electrical mechanical converter, such as a piezoelectric element and the like, and then generating a pressure wave (acoustic wave) in the pressure generating chamber filled with ink. A method of driving an ink jet type recording head, which employs the method, is disclosed in Japanese Laid Open Patent Application (JP-A-Heisei, 6-171080) (a first conventional example) and Japanese Laid Open Patent Application (JP-A 2000-117969) (a second conventional example).

FIG. 7 is a sectional view showing a main portion of the ink jet type recording head in the first conventional example. In the ink jet type recording head, when a driving pulse signal from an external driving circuit is applied between an individual electrode 32 and a common electrode 33 of a laminated piezoelectric element 31, an active portion of the laminated piezoelectric element 31 is contracted in a longitudinal direction, and a vibration plate 36 constituting a bottom plate of a pressure generating chamber 35 is accordingly pulled down. Thus, the capacity within the pressure generating chamber 35 is increased to thereby cause the ink to flow from a common ink chamber 37 through a supply passage 39 to the pressure generating chamber 35.

Next, when the voltage applied between the individual electrode 32 and the common electrode 33 is stopped, the active portion of the laminated piezoelectric element 31 is recovered to thereby reduce the capacity of the pressure generating chamber 35. Then, a pressure generated at that time causes a part of the ink within the pressure generating chamber 35 to be discharged as the ink droplet from a nozzle 40 communicated to the pressure generating chamber 35. Here, symbol 41 of FIG. 7 denotes an elastic plate, symbol 42 denotes a thick portion of the elastic plate, and symbol 43 denotes a head frame.

FIGS. 8A, 8B and 8C are views showing the wave forms of the driving pulse signal and the like. FIG. 8A shows the wave form of the driving pulse signal, FIG. 8B shows a manner of a displacement of a tip of the piezoelectric element, and FIG. 8C shows a deviation of a meniscus resulting from an ink droplet within a nozzle opening caused by a deviation of the piezoelectric element (hereafter, also referred to as an ink meniscus), respectively. As shown in FIG. 8A, the driving pulse signal changes the applied voltage so as to increase the capacity within the pressure generating chamber, in a first period T1 having a time t1, and keeps the applied voltage constant, in a second period T2 having a time t2, and changes the applied voltage so as to reduce the capacity within the pressure generating chamber 35 by the deviation of the piezoelectric element 31, in a third period T3 having a time t3. Such a voltage change enables the vibration caused by the pressure wave (acoustic wave) to be induced in the pressure generating chamber 35.

In FIG. 8B, since a rising time t1 of a voltage pulse is set to be sufficiently longer than a first natural period determined by a frequency of a oscillator, a vibration excited by a discontinuous voltage change between a time 0 and a time (T1) is so small that the piezoelectric element 31 substantially responses according to a change of a voltage pulse. Also, since a trailing time t3 of the voltage pulse is set a time substantially equal to the first natural period, the discontinuous voltage change at a time (T2) leads to an overshoot vibrated at the first natural period. In FIG. 8C, the first period T1 is set to be sufficiently longer than a second natural period in the ink passage affected by each of the acoustic capacitance of the pressure generating chamber 35 and the second period T2 in which the voltage is kept constant. Thus, after the completion of the recovery of the ink meniscus following the ink droplet discharge, the ink droplet is discharged on the basis of the voltage change in the third period T3.

FIG. 9 is a view showing a wave form of a driving pulse signal used in an ink jet recording head of the second conventional example. This driving pulse signal is continuously provided with a first voltage changing step 45, a first voltage keeping step 46, a second voltage changing step 47, a second voltage keeping step 49, a third voltage changing step 50, a third voltage keeping step 51 and a fourth voltage changing step 52.

At the first voltage changing step 45, an applied voltage V to a piezoelectric element is trailed (V1→0) in a time t1. At the first voltage keeping step 46, the trailed applied voltage V is kept only for a time t1a. At the second voltage changing step 47, the voltage is risen (0→V2) in a time t2 in order to contract a pressure generating chamber and then discharge an ink droplet. Also, at the second voltage keeping step 49, the risen applied voltage V is kept only for a time t2a. At the third voltage changing step 50, the voltage is trailed (V2→0) in a time t3 in order to again expand the pressure generating chamber. At the third voltage keeping step 51, the trailed applied voltage V is kept only for a time t3a. And, at the fourth voltage changing step 52, the voltage is again risen (0→V1) in a time t4 in order to generate a pressure wave to suppress reverberation.

The driving pulse signal in the second conventional example increases the capacity of the pressure generating chamber at the first voltage changing step 45, and contracts the capacity of the pressure generating chamber at the second voltage changing step 47, and again increases the capacity of the pressure generating chamber at the third voltage changing step 50. A time for the pressure wave generated by the pressure generating chamber in response to the driving pulse signal to complete the series of deviations (the natural period) is assumed to be Tc. Then, the voltage change periods t2, t3 at the second and third voltage changing steps 47, 50 respectively have the relation with regard to the natural period Tc, as follows:

0<t2<Tc/2

0<t3<Tc/2

In the first conventional example, the ink amount of the discharged ink droplets is determined only by the applied voltage. Thus, it is necessary to reduce the applied voltage V in order to discharge the smaller ink droplet. However, if the applied voltage V is reduced, the voltage change is also reduced in the third period T3 in which the ink droplet is discharged. Hence, this brings about a trouble that a sufficient ink droplet discharge velocity (hereafter, also referred to as a droplet velocity) can not be obtained. In this case, a position where it is put at a recording medium is deviated, which deteriorates an image quality. Also, this results in a problem that the ink discharge itself is not carried out.

In the second conventional embodiment, the voltage change periods t2, t3 at the second and third voltage changing steps 47, 50 respectively are defined in order to obtain the driving pulse signal so that the micro ink droplet is stably discharged at a high driving frequency. In order to carry out a recording operation at such a high driving frequency, it is necessary to shorten a length of the entire wave form of the driving pulse signal. Since the pressure waves generated at the respective voltage changing steps affect each other, it is necessary to maintain the times necessary for the respective voltage changing steps, the mutual time intervals between the respective steps, and the relation between the time and the natural period of the generated pressure wave at the high accuracies. However, the second conventional example does not clearly define the voltage change period t1 at the first voltage changing step 45, and the time t1a between the first and second voltage changing steps 45, 47.

The present invention is proposed in view of the above-mentioned circumstances. It is therefore an object of the present invention to provide a method of driving an ink jet type recording head, which can obtain a sufficient ink droplet discharge velocity even if an applied voltage V is low, and use a driving pulse signal so that a relation between a natural period of a generated pressure wave and a voltage change time and the like can be kept at a high accuracy.

### SUMMARY OF THE INVENTION

In order to attain the above-mentioned object, a method of driving an ink jet type recording head according to the present invention includes a plurality of pressure generating chambers communicated to an ink chamber filled with ink and piezoelectric elements arranged correspondingly to the respective pressure generating chambers, in which an ink droplet is discharged from a nozzle communicated to the pressure generating chamber on the basis of an applied driving pulse signal,

wherein the driving pulse signal continuously has a first period T1 in which the pressure generating chamber is expanded, a second period T2 in which an expansion state of the pressure generating chamber is kept, and a third period T3 in which the pressure generating chamber is contracted, and

when a natural period of the pressure generating chamber is assumed to be Tc, the first period T1 and the second period T2 satisfy the equation given by:

3Tc/8≦T1+T2≦5Tc/8

In the method of driving an ink jet type recording head according to the present invention, the relation between the sum T1+T2 of the first and second periods and the natural period Tc is set at 3Tc/8≦T1+T2≦5Tc/8. Thus, phases of meniscus displacements in the expansion and the contraction resulting from the driving pulse signal can be made substantially coincident with each other. Also, a pressure wave generated in the pressure generating chamber can be obtained as the wave form in which both wave forms resulting from the expanding step and the contracting step are superimposed on each other. Hence, even if the driving pulse signal having a voltage lower than that of the conventional method is applied, it is possible to attain the sufficient ink droplet discharge velocity. Here, since the sum T1+T2 of the first and second periods are established so as to belong to the range between 3Tc/8≦T1+T2≦5Tc/8, the ink droplet discharge velocity obtained by the application of the driving pulse signal can be set at a velocity value in a proper range including a maximum velocity. Hence, for example, even if changes in the natural period caused by the variation in a part dimension or the like or a disturbances such as an environmental change occur, their influences can be suppressed to thereby attain the ink discharge property that is always stable.

Here, [Natural Period Tc] used in the present invention implies a time necessary for one reciprocation of the pressure wave generated within the pressure generating chamber. It is observed as a vibration period of the meniscus in the nozzle. In other words, the natural period Tc is a period natural to an ink route system affected by acoustic capacitance. It implies a period when the pressure wave generated within the pressure generating chamber repeats the reciprocation while it is attenuated between the nozzle and an ink supply hole.

Here, the sum of the first period T1 and the second period T2 is desired to belong to a range between 7Tc/16 and 9Tc/16. In this case, it is possible to obtain the ink droplet discharge property which is further stable.

In the preferable method of driving an ink jet type recording head according to the present invention, a voltage change in the first period can be set to be smaller than a voltage change in the third period. In this case, after the contraction state of the pressure generating chamber in the third period is kept, the capacity of the pressure generating chamber can be expanded by stages. Thus, the ink droplet discharge property is further stable.

Also, it is a preferable configuration to further include a pre-expansion period in which the pressure generating chamber is expanded in advance prior to the first period, and a pre-expansion keeping period which proceeds to the first period while an expansion state of the pressure generating chamber expanded in the pre-expansion period is kept. In this case, after the ink meniscus largely withdrawn at the previous expanding step is sufficiently recovered by the intervention of the pre-expansion keeping period, it is possible to carry out the expanding step in the first period.

### BRIEF DESCRIPTION OF THE DRAWINGS

FIG. 1A is a sectional view showing a configuration of a main portion of an ink jet type recording head according to a first embodiment of the present invention, at an assembled state;

FIG. 1B is a sectional view showing a recording head at a developed state;

FIG. 2 is a view showing an example of a wave form of a driving pulse signal in the ink jet type recording head according to the first embodiment;

FIG. 3A is a view showing a manner of a vibration of a meniscus when an expanded wave form in a first period is applied, in a graph showing a relation between a meniscus velocity and a time;

FIG. 3B is a view showing a manner of a vibration of a meniscus when a compressed wave form in a third period is applied;

FIG. 4 is a graph view showing a relation between a summed time of the first and second periods and an ink droplet discharge velocity;

FIG. 5 is a view showing a wave form of a driving pulse signal according to a second embodiment of the present invention;

FIG. 6 is a view showing a wave form of a driving pulse signal according to a second embodiment of the present invention;

FIG. 7 is a sectional view showing a main portion of a conventional ink jet type recording head;

FIG. 8A is a view showing a driving pulse wave form;

FIG. 8B is a view showing a manner of a displacement at a tip of a piezoelectric element;

FIG. 8C is a view showing a displacement of a meniscus resulting from an ink droplet within a nozzle opening caused by a deviation of a piezoelectric element; and

FIG. 9 is a view showing a voltage change in a driving pulse wave form, in another method of driving a conventional ink jet recording head.

### DETAILED DESCRIPTION OF THE PREFERRED EMBODIMENTS

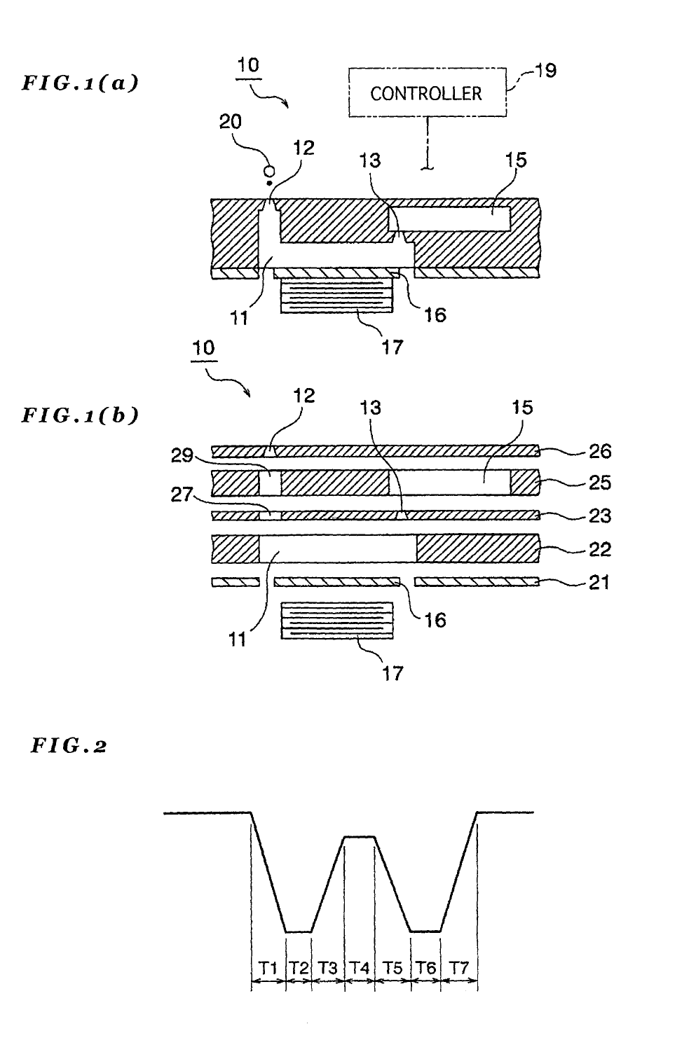

The present invention will be described below in detail with reference to the attached drawings, on the basis of embodiments of the present invention. FIG. 1A is a sectional view showing the configuration of a main portion of an ink jet type recording head according to a first embodiment of the present invention, at an assembled state, and FIG. 1B is a sectional view showing a recording head at a developed state.

As shown in FIG. 1A, an ink jet type recording head 10 is provided with: a plurality of pressure generating chambers 11; nozzles 12 respectively communicated to the respective pressure generating chambers 11; a common ink chamber 15 commonly communicated to all the pressure generating chambers 11 through ink supply holes 13 respectively corresponding to the pressure generating chambers 11; a piezoelectric element 17 fixed to a bottom plate 16 of each of the pressure generating chambers 11; and a controller 19 for individually outputting a driving pulse signal to each of the piezoelectric elements 17 within a substrate in which a plurality of plates are mutually adhered and fixed.

The controller 19 is composed of a micro computer and the like. It outputs the driving pulse signal and thereby controls an operation of each of the piezoelectric elements 17 and then discharges the ink supplied through the ink supply hole 13 from the common ink chamber 15 as an ink droplet 20 from the nozzle 12 by pressure generated within the pressure generating chamber 11 by acoustic wave.

As shown in FIG. 1B, the ink jet type recording head 10 at a disassembled state is composed of: a vibration plate 21 constituting the bottom plate 16; a pressure plate 22; a supply plate 23; an ink chamber plate 25; and a discharge plate 26, in order on the piezoelectric element 17.

The pressure generating chamber 11 of the pressure plate 22 in which the top and bottom portions are blocked by the supply plate 23 and the vibration plate 21 is communicated through the ink supply hole 13 to the common ink chamber 15. The ink is sequentially supplied to the common ink chamber 15 from an ink cartridge (not shown). The ink filled in the common ink chamber 15 is sent through the ink supply hole 13 to the pressure generating chamber 11, and further sent through a penetration hole 27 formed in the supply plate 23 and a penetration hole 29 formed in the ink chamber plate 25 to the nozzle 12.

At the ink jet type recording head 10 having the above-mentioned configuration, when the driving pulse signal is outputted by the controller 19, the bottom plate 16 of the vibration plate 21 is vibrated by the operation of the corresponding piezoelectric element 17, and this vibration changes a capacity in the pressure generating chamber 11. Thus, a pressure wave (acoustic wave) is generated in the pressure generating chamber 11. Moreover, this pressure wave causes a part of the ink filled in the pressure generating chamber 11 to be discharged from the nozzle 12, and jumped as the ink droplet 20 having a predetermined size. The jumped ink droplet 20 adheres onto a recording medium, such as a recording paper and the like, located at a slight interval from the nozzle 12, and constitutes a dot. Such dot formation is repeated on the basis of given image data. Hence, a letter or an image is recorded on the recording medium.

FIG. 2 is a view showing an example of a wave form of the driving pulse signal of the ink jet type recording head 10. This driving pulse signal is outputted from the controller 19 to the piezoelectric element 17. It continuously has a first period T1 necessary for the expansion of the pressure generating chamber 11, a second period T2 in which the expansion state of the pressure generating chamber 11 expanded in the first period T1 is kept, and a third period T3 necessary for the contraction of the pressure generating chamber 11 after an elapse of the second period T2.

Moreover, the driving pulse signal continuously has a fourth period T4 in which the contraction state of the pressure generating chamber 11 contracted in the third period T3 is kept, a fifth period T5 necessary for the expansion of the pressure generating chamber 11 after an elapse of the fourth period T4, a sixth period T6 in which the expansion state of the pressure generating chamber 11 expanded in the fifth period T5 is kept, and a seventh period T7 necessary for the contraction of the pressure generating chamber 11 after an elapse of the sixth period T6.

The driving pulse signal according to this embodiment continuously has the first period T1 in which the pressure generating chamber 11 is expanded, the second period T2 in which the expansion state of the pressure generating chamber 11 is kept, and the third period T3 in which the pressure generating chamber 11 is contracted. Let us suppose that a natural period of the pressure generating chamber 11 is Tc. Then, the first period T1 and the second period T2 are defined so as to satisfy the following equation:

3Tc/8≦T1+T2≦5Tc/8

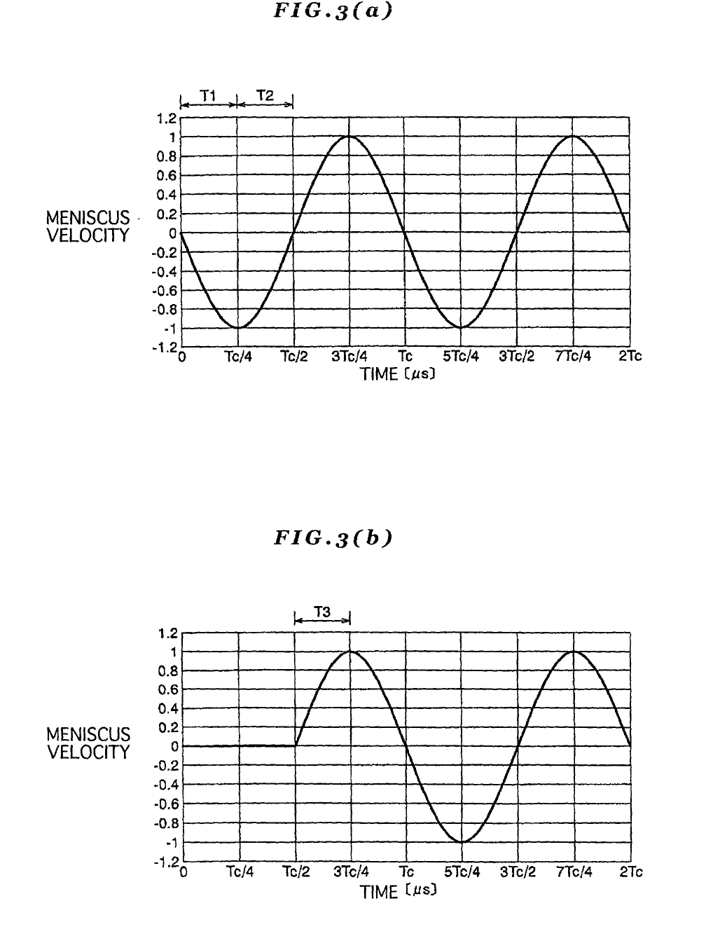

The natural period Tc can be observed as a vibration period of a meniscus in an opening of the nozzle 12. FIGS. 3A, 3B are graphs showing the relation between a meniscus velocity and a time. FIG. 3A shows a manner of a vibration of the meniscus when an expansion wave in the first period is applied, and FIG. 3B shows a manner of a vibration of the meniscus when a compression wave in the third period is applied. Horizontal axes in both the graphs indicate a time [μs], and vertical axes thereof indicate a non-dimensional velocity at a time of a deviation of the meniscus (a velocity in which the meniscus velocity for each time is divided by its maximum velocity), respectively.

FIG. 3A shows the meniscus velocity until the attenuation after the meniscus is vibrated by its recovering force, when the expansion state of the pressure generating chamber 11 is kept in the second period T2 after only one pulse of the expansion wave in the first period T1 is applied to the piezoelectric element 17, by extracting two cycles of the natural period Tc after the start of the voltage application. As can be understood from FIG. 3A, when the expansion wave (T1) of the driving pulse signal in FIG. 2 is applied to the piezoelectric element 17, the meniscus is largely withdrawn from the nozzle opening in the block between 0 and Tc/4 [μs]. Then, after the meniscus velocity becomes the minus maximum velocity of −1, while the expansion state of the pressure generating chamber 11 is kept in the second period T2 in the block between Tc/4 and Tc/2 [μs], it is returned back toward the nozzle opening by the recovering force of the meniscus itself. Due to the inertia at the time of this recovery, in the block between Tc/2 and 3Tc/4 [μs], the meniscus is protruded from the nozzle opening, and the meniscus velocity becomes maximum. Moreover, it is returned to the nozzle opening by the recovering force of the meniscus itself, in the block between 3Tc/4 and Tc [μs]. After Tc, the meniscus repeatedly vibrates while attenuating.

Also, FIG. 3B shows the deviation until the attenuation after the meniscus is vibrated by its recovering force, after the application of only one pulse of the contraction wave in the third period T3, in time to a timing of the recovery of the meniscus when the expansion state of the pressure generating chamber 11 is kept in the second period T2, by extracting two cycles of the natural period Tc. As can be understood from FIG. 3B, when the compression wave (T3) of the driving pulse signal shown in FIG. 2 is applied at a delay of Tc/2 [μs] in time to the timing of the meniscus recovered when the expansion state of the pressure generating chamber 11 is kept, in the block between Tc/2 and 3Tc/4 [μs], the meniscus is protruded from the nozzle opening by the compression wave, and it becomes at the maximum discharge velocity. It is returned back to the nozzle opening by the recovering force of the meniscus itself, in the block between 3Tc/4 and Tc [μs]. Due to the inertia at the time of this recovery, in the block between Tc and 5Tc/4 [μs], the meniscus is withdrawn from the nozzle opening, and it becomes at the minus maximum velocity. Moreover, in the block between 5Tc/4 and 3Tc/2 [μs], it is returned back to the nozzle opening by the recovering force of the meniscus itself. After Tc, the meniscus repeatedly vibrates while attenuating.

In short, when the driving pulse signal in this embodiment is applied to the piezoelectric element 17, the pressure generating chamber 11 is expanded in the block (T1) between 0 and Tc/4. In the block (T2) between Tc/4 and Tc/2 in which this expansion is kept, the meniscus is returned towards the nozzle opening. However, at this time, in time to the timing when the meniscus is protruded from the nozzle opening by the inertia, the compression wave causes the pressure generating chamber 11 to be contracted in the block (T3) between Tc/2 and 3Tc/4. In this way, by inverting the wave form at a timing of the half of the natural period Tc, it is possible to superimpose the wave form causing the meniscus to be protruded from the nozzle opening after the elapse of the second period T2 and the wave form causing the meniscus to be protruded from the nozzle opening after the compression in the third period T3, on each other. Thus, even if the applied voltage is lower, it is possible to obtain the compression wave to attain the sufficient ink droplet discharge velocity.

In short, in this embodiment, the sum T1+T2 of the first period T1 necessary for the expansion of the pressure generating chamber 11 and the second period T2 necessary for the keeping of the expansion state is set at T1+T2=Tc/2. So, respective phases of the meniscus deviations resulting from the expansion wave and the compression wave can be made substantially coincident with each other. For this reason, as mentioned above, even if the driving pulse signal is constituted at a relatively low voltage, the pressure wave generated in the pressure generating chamber 11 is formed by superimposing both the protruded wave forms resulting from the expanding step and the compressing step on each other. Thus, it is possible to attain the sufficient ink droplet discharge velocity. At this time, respective peaks of both the wave forms resulting from the expanding step and the compressing step can be made substantially coincident with each other. Hence, even if changes in the natural period Tc caused by the variation in a part dimension or the like or disturbances such as an environmental change occur, its influence can be suppressed. Hence, it is possible to obtain the ink droplet discharge velocity which is effective and sufficient.

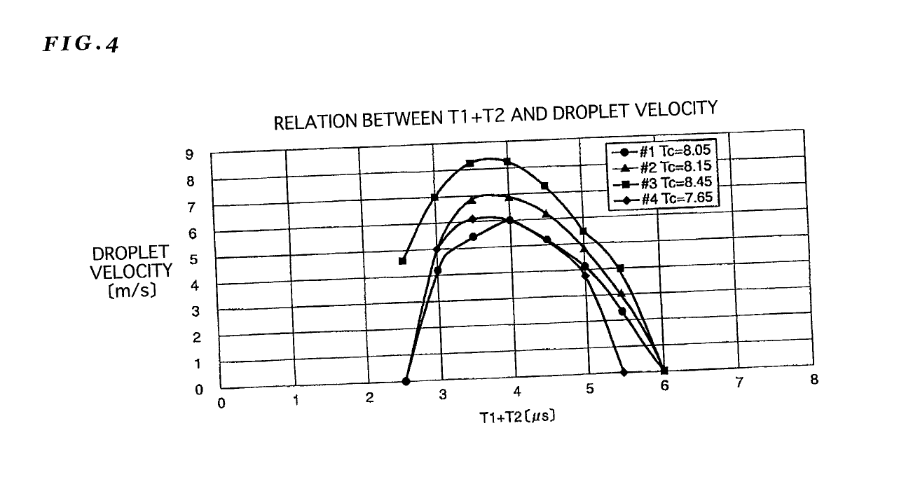

By the way, the droplet velocity when a length of the first period T1 is made constant as an experiment and a length of the second period T2 is changed is measured for the recording head in which the natural periods Tc are different from each other. Then, the result shown in FIG. 4 is obtained. FIG. 4 is a graph showing the relation between the sum [μs] of the first and second periods T1, T2 and the ink droplet discharge velocity [m/s], and it shows the change in the ink droplet discharge velocity caused by the difference between the vibration wave forms. A time on a horizontal axis is indicated at 0 to 8 [μs]. Symbol ● indicates an example in which the natural period Tc is 8.05 μs. Symbol ▴ indicates an example in which the natural period Tc is 8.15 μs. Symbol ▪ indicates an example in which the natural period Tc is 8.45 μs. And, Symbol ♦ indicates an example in which the natural period Tc is 7.65 μs.

The above-mentioned change in the ink droplet discharge velocity is proportional to the vibration velocity of the meniscus. Thus, by measuring the ink droplet discharge velocity, it is possible to determine the strength of the pressure wave generated within the pressure generating chamber 11. As shown in the graph, the droplet velocity in each of the examples exhibits the peak when the sum T1+T2 of the first and second periods is about Tc/2, namely, when it is 4 μs. Also, at a time of 1/8 Tc (3.5 μs, 4.5 μs) before and after the peak in each example, the attenuation amount of the droplet velocity is suppressed so as not to exceed 20% of the peak.

On the contrary, at the times beyond 1/8 Tc before and after the respective peaks (0 to 35 μs, 4.5 to 8 μs), the droplet velocity is extremely reduced in the respective examples. In short, in the example ● in which the natural period Tc of the pressure generating chamber 11 is 8.05 μs, the example ♦ in which the natural period Tc is 7.65 μs and the example ▴ in which the natural period Tc is 8.15 μs, the discharge can not be carried out at the times between 1/8 Tc and 2/8 Tc before and after each peak. Also, in the example ▪ in which the natural period Tc is 8.45 μs, the discharge does not become impossible at the time before the peak. However, the discharge becomes impossible at the time between 1/8 Tc and 2/8 Tc after the peak.

In this way, even if the energies acting on the pressure generating chamber 11 through the expansion and the contraction are substantially similar to each other, if the timing, namely, the time of the sum T1+T2 of both the periods of the expansion and the contraction is suitably changed, it is understood that the droplet velocity can be changed by modifying the superimposed state of the wave forms explained with reference to FIG. 3. In this way, by mutually superimposing the pressure wave forms in the first and second periods T1, T2 so as to cancel each other or duplicate them, the efficiency in the ink discharge can be modified to thereby suitably set the ink droplet discharge velocity. Such difference in the ink droplet discharge velocity can be understood by viewing any one of the graph lines in FIG. 4 from the horizontal axis direction.

If the same driving pulse signal is applied to the pressure generating chambers 11 in which the natural periods Tc are different, a wave form is inputted to a certain pressure generating chamber 11 at a state of a deviated timing. The superimposed state of the pressure wave forms is different from that in the application of the proper driving pulse signal. Thus, this difference results in the difference between the ink droplet discharge velocities. This difference can be understood when the plurality of graph lines in FIG. 4 are viewed from the vertical axis direction. By the way, the reason why the droplet velocity at the peaks in the respective graph lines do not always coincide with each other lies in the factor of the variation besides the driving wave form and the natural period.

In view of the above explanation, the sum T1+T2 of the first period T1 necessary for the expansion of the pressure generating chamber 11 and the second period T2 necessary for the keeping of the expansion state is assumed to be the condition of Ti+T2=Tc/2. Then, it is further assumed to be a condition of 3Tc/8≦T1+T2≦5Tc/8. So, the range of T1+T2 is properly set. Thus, it is possible to attain the driving pulse signal from which the further effective discharge effect can be obtained.

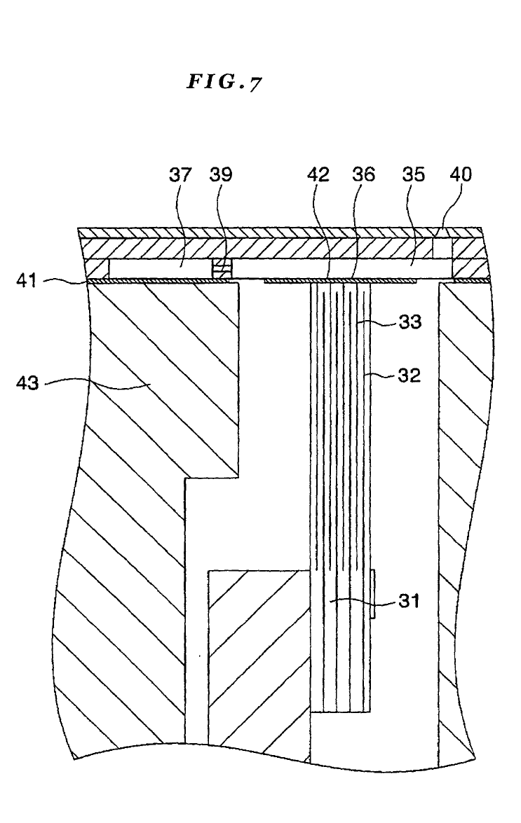

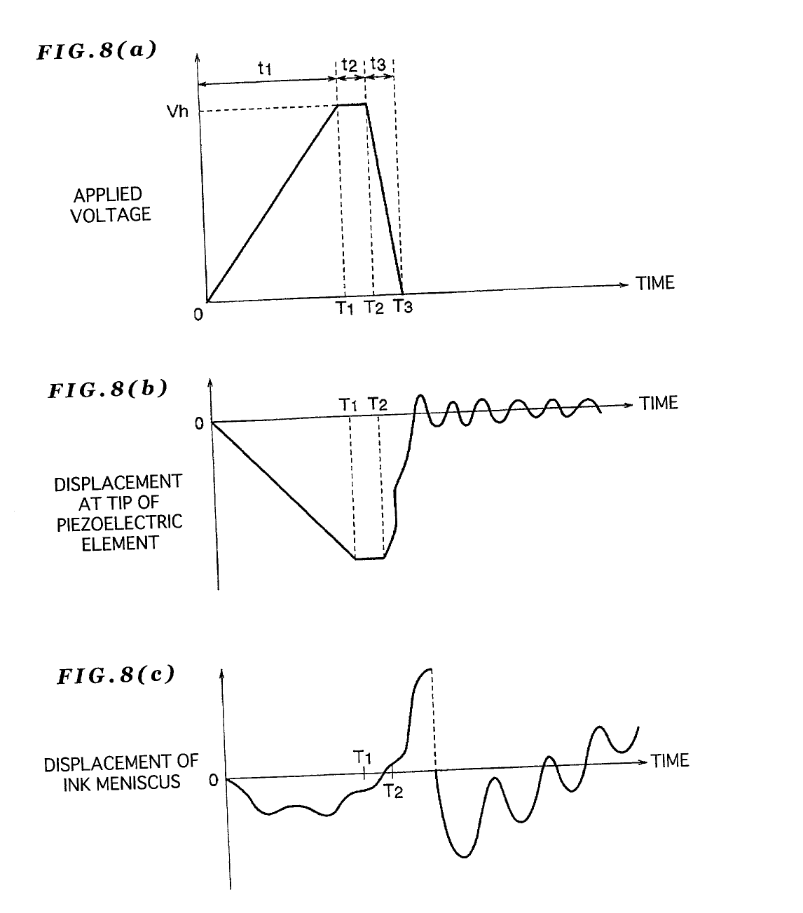

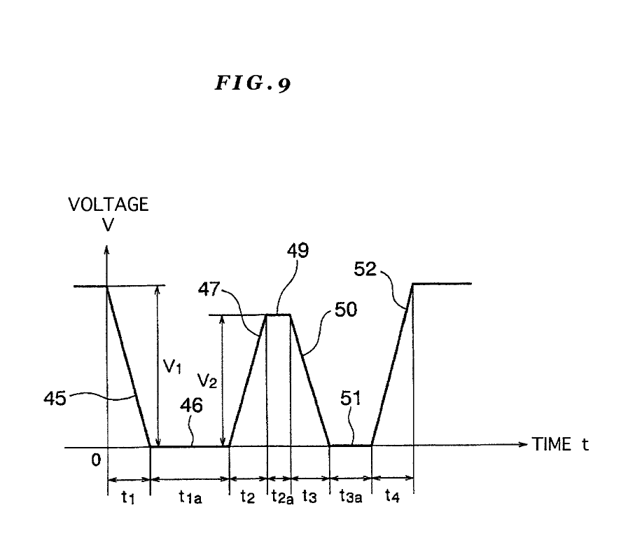

As mentioned above, the relation between the natural period Tc and the sum T1+T2 of both the first and second periods is set at 3Tc/8≦T1+T2≦5Tc/8. Thus, the phases of the respective meniscus deviations resulting from the expansion wave and the compression wave can be substantially coincident with each other to thereby obtain the pressure wave generated within the pressure generating chamber 11 as the wave form in which both the protruded wave forms resulting from the expansion and the compression are superimposed on each other. For example, the conventional driving method illustrated in FIGS. 7, 8 does not use the pressure wave resulting from the first period T1, and it merely discharges the ink droplet only at the compressing step in the third period T3. However, in this embodiment, the ink droplet discharge velocity can be obtained by superimposing the expansion wave and the compression wave on each other. Hence, even if the driving pulse signal having the voltage lower than that of the conventional method is applied, it is possible to obtain the sufficient ink droplet discharge velocity exceeding the actually applied voltage.

Also, as illustrated in FIG. 4, the sum T1+T2 of the first and second periods is set at the range between 3Tc/8 and 5Tc/8. Thus, the ink droplet discharge velocity obtained by the application of the driving pulse signal can be obtained as the value from the maximum value (peak) to 80% of the maximum value. Hence, even if changes in the natural period Tc caused by the variation in the part dimension or the like or disturbances such as the environmental change occur, their influences can be suppressed to thereby attain the ink discharge property that is always stable. Also, as can be understood from FIG. 4, if the sum T1+T2 of the first and second periods belongs to a range between 7Tc/16 and 9Tc/16, it is possible to obtain the excellent ink droplet discharge velocity.

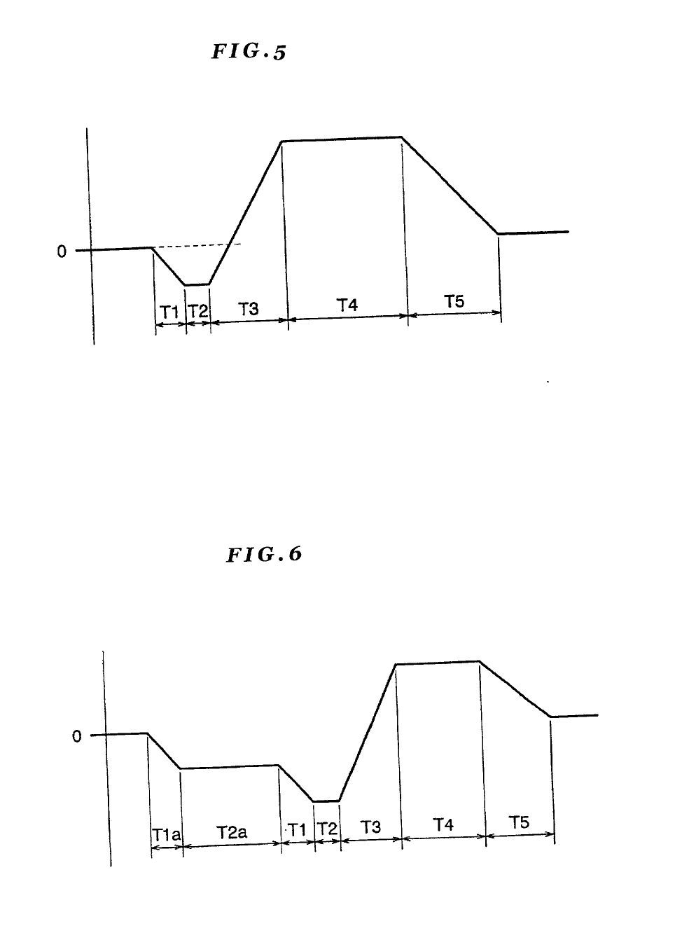

FIG. 5 is a view showing a wave form of a driving pulse signal according to a second embodiment of the present invention. The driving pulse signal in this embodiment has the basic wave form similar to that of the first embodiment. However, when a signal potential at a time of a start of an application in FIG. 5 is assumed to be 0 V, a rate of a contraction on a plus side is greater than a rate of an expansion on a minus side on a vertical axis, in the third period T3. The entire wave form is set to be relatively longer in the horizontal axis direction. Thus, it is possible to discharge the ink droplets larger than the ink droplet discharge amount when the driving pulse signal shown in FIG. 2 is applied.

FIG. 6 is a view showing a wave form of a driving pulse signal according to a third embodiment of the present invention. The driving pulse signal in this embodiment is configured such that a modified shape is added to the driving pulse signal shown in FIG. 5. It continuously has the first, second and third periods T1, T2 and T3, similarly to the first and second embodiments. Even if any other steps (periods) are included before and after the first and third periods T1, T3, it is possible to obtain the effect of the present invention.

A method of increasing a potential on a minus side on a vertical axis in the graph may be considered in order to increase the ink droplet amount by reserving a potential difference. However, the meniscus in the opening of the nozzle 12 is largely withdrawn immediately after a large quantity of expansion is carried out at one time in the pressure generating chamber 11. This brings about a trouble that even if the contraction is carried out at the state, the discharged ink amount is not increased. In order to avoid such trouble, this embodiment has a pre-expansion period T1a in which a pre-expansion of the pressure generating chamber 11 is carried out, and a pre-expansion keeping period T2a in which the expansion state of the pressure generating chamber 11 expanded in the pre-expansion period T1a is kept, at a former stage of the driving pulse signal of FIG. 5.

Thus, the ink meniscus largely withdrawn at the previous expanding step can be sufficiently recovered by the intervention of the pre-expansion keeping period T2a. After that, it is possible to carry out the expanding step in the first period T1.

As mentioned above, the present invention has been described in accordance with the preferable embodiments. However, the method of driving an ink jet type recording head according to the present invention is not limited to only the configurations of the above-mentioned embodiments. A method of driving an ink jet type recording head to which various modifications and changes are made from the configurations of the above-mentioned embodiments is included in the range of the present invention.

As mentioned above, according to the present invention, it is possible to obtain the sufficient ink droplet discharge velocity even if the applied voltage is low. Also, it is possible to obtain the method of driving an ink jet type recording head, which uses the driving pulse signal that can keep the relation between the voltage change time and the natural period of the generated pressure wave at a high accuracy.

The invention may be embodied in other specific forms without departing from the spirit or essential characteristic thereof. The present embodiments are therefore to be considered in all respects as illustrative and not restrictive, the scope of the invention being indicated by the appended Claims rather than by the foregoing description and all changes which come within the meaning and range of equivalency of the Claims are therefore intended to be embraced therein.

The entire disclosure of Japanese Patent Application No. 2001-61435 (filed on Mar. 6^{th}, 2001) including specification, claims, drawings and summary are incorporated herein by reference in its entirety

What is claimed is:

1. A method of driving an ink jet type recording head including a plurality of pressure generating chambers communicated to an ink chamber filled with ink and piezoelectric elements arranged correspondingly to the respective pressure generating chambers, in which an ink droplet is discharged from a nozzle communicated to the pressure generating chamber on the basis of an applied driving pulse signal,
wherein said driving pulse signal continuously has a first period T1 in which said pressure generating chamber is expanded, a second period T2 in which an expansion state of said pressure generating chamber is kept, and a third period T3 in which said pressure generating chamber is contracted, and
when a natural period of said pressure generating chamber is assumed to be Tc, said first period T1 and said second period T2 satisfy the equation given by:
3Tc/8≦T1+T2≦5Tc/8

2. A method of driving an ink jet type recording head according to claim 1, wherein a sum of said first period T1 and said second period T2 belongs to a range between 7Tc/16 and 9Tc/16.

3. A method of driving an ink jet type recording head according to claim 1, wherein a sum of said first period T1 and said second period T2 is Tc/2.

4. A method of driving an ink jet type recording head according to claim 1, wherein said third period T3 is set to be longer than said first period T1, and a potential of said driving pulse signal at an end of said third period T3 is higher than a potential in said first period T1.

5. A method of driving an ink jet type recording head according to claim 1, wherein said driving pulse signal further has a pre-expansion period in which said pressure generating chamber is expanded in advance prior to said first period, and a pre-expansion keeping period which proceeds to said first period while an expansion state of said pressure generating chamber expanded in said pre-expansion period is kept.
